(19) United States
(12) Patent Application Publication
(10) Pub. No.: US 2022/0094166 A1
(43) Pub. Date: Mar. 24, 2022

(54) DIRECT CURRENT CHILLER METHOD AND SYSTEM

(71) Applicant: SMARDT CHILLER GROUP INC., Dorval (CA)

(72) Inventors: Vincent CANINO, Foothill Ranch, CA (US); Gregory TUTWILER, Bridgewater, VA (US); Peter SWAN, Bowral (AU); Scott JOHNSON, Saint-Laurent (CA); Roger RICHMOND-SMITH, Montreal (CA)

(21) Appl. No.: 17/422,577

(22) PCT Filed: Jan. 14, 2020
(86) PCT No.: PCT/CA2020/050034

§ 371 Date: Jul. 13, 2021

Related U.S. Application Data
(60) Provisional application No. 62/791,992, filed on Jan. 14, 2019.

(51) Int. Cl. H02J 3/38; F24F 11/88; F25B 27/00; F25B 30/02

(52) U.S. Cl. CPC H02J 3/38; F25B 30/02; F25B 27/00; F24F 11/88

(57) ABSTRACT

A method and system for power supply integration, comprising interfacing at least one of: i) an AC power supply and ii) a DC power supply, and supplying, from the at least one of: i) an AC power supply and a ii) a DC power supply, DC power to the at least one DC load. The energy supply to the at least one DC load from the at least one AC power supply and the at least one DC power supply is controlled so as to selectively supply power from renewable energies for example.

### FIELD OF THE INVENTION

The present invention relates to a chiller method and system. More specifically, the present invention is concerned with a method and a system for a direct current chiller.

### BACKGROUND OF THE INVENTION

Heating, ventilation and air-conditioning and refrigeration (HVACR) systems consume approximately 50% of an average building's electrical energy load. With electricity costs on a steady rise, it only makes sense for building owners to focus on energy savings in their HVAC systems. The bulk of electricity in the US is transmitted over an alternating current (AC) transmission and distribution (T&D) system which is an aging infrastructure of transmission power lines. These aging lines continue to degrade in efficiency, which is a major contributing factor to rising electricity costs. Not only are these transmission lines aging at significant inefficiencies, the cost to upgrade T&D lines ranges from $1 MM to $5 MM USD per mile. This dilemma is now forcing building owners to focus on efficiency improvements around the existing energy delivery systems.

In light of aging T&D infrastructure as described above as well as today's buildings integrating more DC driven products such as renewable energy, battery storage and LED lighting, solutions utilizing DC distribution and generation are seen as an opportunity for additional efficiencies in a building's energy portfolio. Studies and simulations have shown that buildings using DC distribution and DC powered products provide from 9% to 25% gains in efficiencies. FIG. 1 is a schematic of how studies approached the DC conversion (taken from Daniel L. Gerber, et al, “A Simulation-Based Efficiency Comparison of AC and DC Power Distribution Networks in Commercial Buildings”, Applied Energy, Vol. 210, 2018, 1167-1187).

The future is now looking at solutions that include distributed generation. With today's technology that can now leverage the power of DC generation, especially from renewable energies, DC distributed generation is gaining wider acceptance as a decentralized, modular, and flexible technology, which is located close to the load being served. Studies have shown that buildings using DC powered products provide from 18% to 25% gains in efficiencies. A major driver to DC driven buildings has been the acceptance of LED lighting, which is 100% DC driven.

Currently, compressors typically take AC power and convert a portion thereof to DC power, and chillers represent some of the most intensive energy consuming products within the modern built environment, accounting for up to 60% of energy costs for an entire building.

A chiller typically contains multiple energy consuming motors to drive the refrigeration cycle, including compressors and fans. Historically these motors would be AC motors running at a single speed dictated by the frequency of the AC grid's power supply. As demand for energy saving devices grew these single speed motors begun to be replaced by variable speed motors that operated at speeds independent of the grid's AC frequency, thus enabling to match varying demand and save power. These variable speed solutions convert the AC power to DC power, involving some minor power loss, before creating a variable frequency output to drive the motors. These power converters are often developed to facilitate packaging constraints that may sacrifice efficiency and/or electrical noise for the convenience of integration into the motor itself.

There is still a need in the art for a direct current chiller method and system.

### SUMMARY OF THE INVENTION

More specifically, in accordance with the present invention, there is provided a system comprising a power control module, at least one power supply and at least one DC load, the power control module interfacing the at least one DC load and the at least one power supply.

There is further provided a power supply integration method, comprising interfacing at least one DC load and at least power supply.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic of Office Building DC Network (from Daniel L. Gerber, et al, “A Simulation-Based Efficiency Comparison of AC and DC Power Distribution Networks in Commercial Buildings”, Applied Energy, Vol. 210, 2018, 1167-1187);

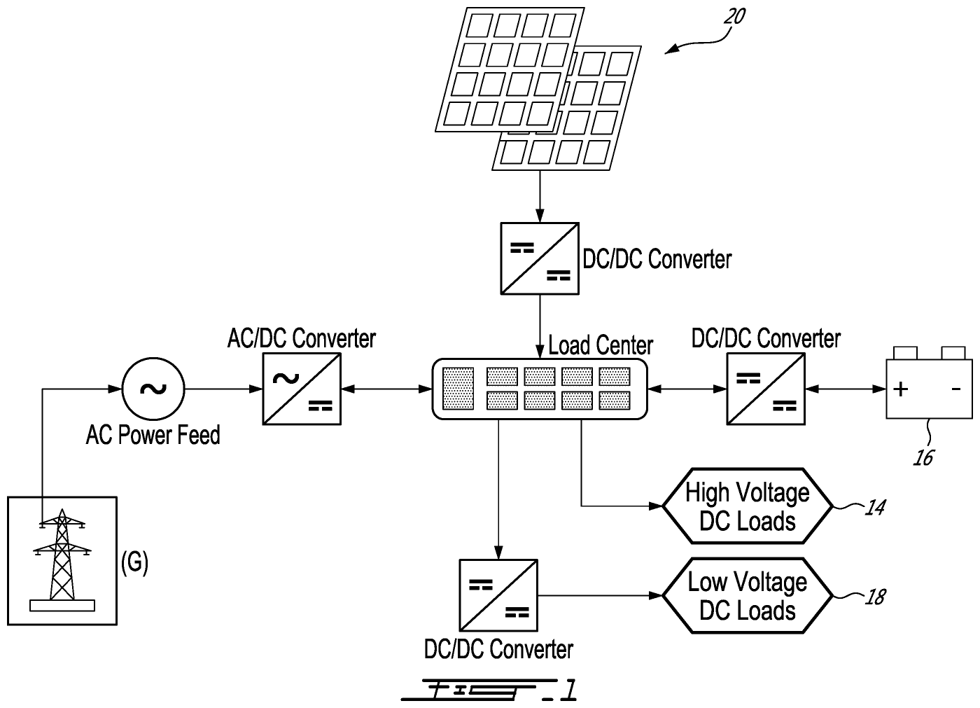

FIG. 2 is a schematic of a DC chiller integrated with a DC distributed generation system and existing AC distribution according to an embodiment of an aspect of the present invention; and

FIG. 3 shows a power control module according to an embodiment of an aspect of the present invention, designed to accept multiple disparate sources/sinks of electrical energy such as solar panels, wind turbines, batteries and the grid.

### DESCRIPTION OF ILLUSTRATIVE EMBODIMENTS

The present invention is illustrated in further details by the following non-limiting examples.

In a nutshell, there is provided a chiller comprising an oil free magnetic bearing compressor which takes AC power and converts the AC power to DC power in order to power the shaft levitation system, compressor motor and on board variable frequency drive (VFD).

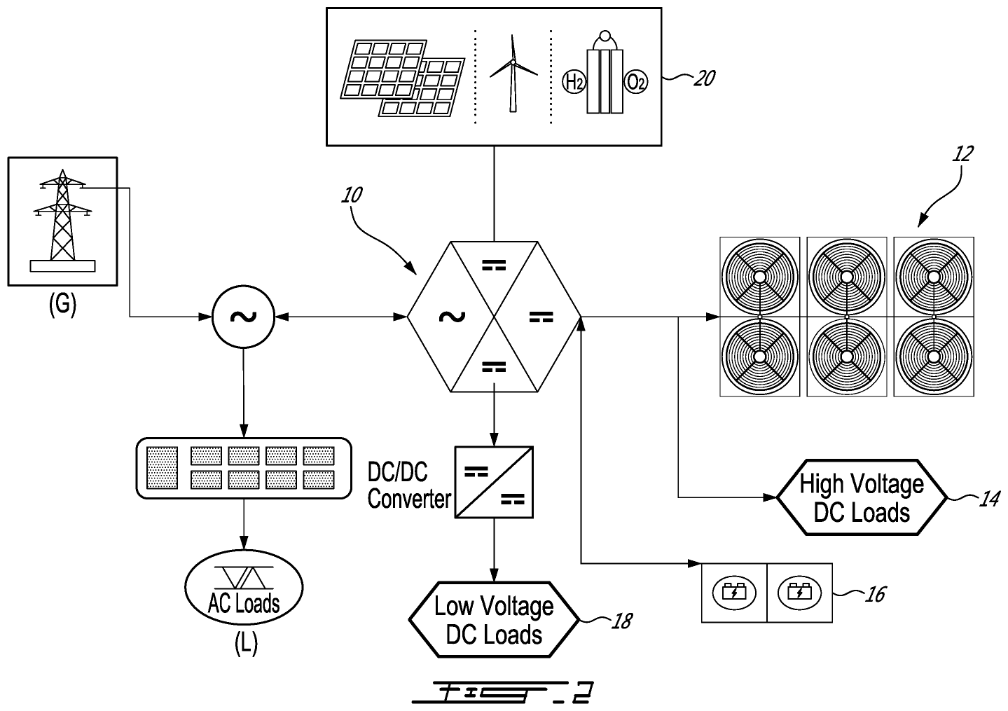

A schematic of a system integrating a DC chiller with a DC distributed generation and existing AC distribution according to an aspect of the present invention is shown in FIG. 2.

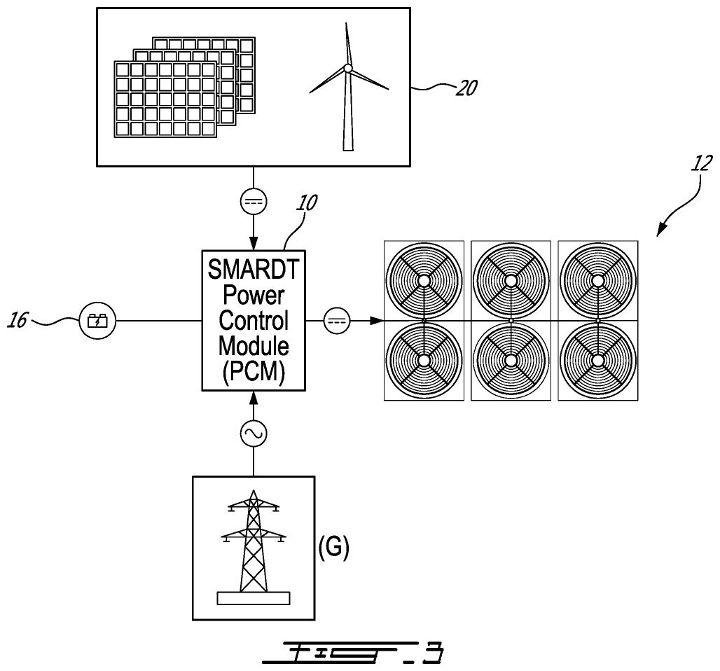

A power control module 10 interfaces the grid (G) delivering AC power typically directed to AC loads (L) with DC loads 12, 14, 16, 18 and DC sources 20. FIG. 3 shows a power control module according to an embodiment of an aspect of the present invention, designed to accept multiple disparate sources/sinks of electrical energy such as solar panels, wind turbines, batteries and the grid.

DC loads may be high voltage DC loads 14, batteries (16), low voltage DC loads 18.

A chiller 12 with DC powered oil free magnetic bearing compressor is integrated within the system. All chiller components, including the compressor, controls, powered valves, and in the case of an air-cooled chiller, the condenser coil fans are 100% DC powered.

For example, modifications in the controls are made in order to monitor DC current and voltages to properly operate the compressor(s) and the overall chiller:

The single DC power source as provided by the power control module 10 eliminates the need for individual inductive reactors for each motor of the chillers for example and is also able to deliver cleaner power consumption, delivering very low harmonic distortion (electrical noise) that tends to increase AC power transmission losses and compromise weaker electrical infrastructure

As people in the art will appreciate, the present system does not use AC power conversion components, thereby avoiding inherent efficiency losses due to the conversion process from AC to DC.

The chiller 12 comprising a DC powered compressor, as well as the power control module 10 are 100% DC powered.

The conversion to DC of the chiller components, including the compressor, controls, powered valves, and in the case of an air-cooled chiller, the condenser coil fans, according to the present disclosure allows efficiency gains. Typically, assuming a DC conversion improves building efficiencies by 15% and the chiller represents 35% of a building load, a 5% gain in efficiency may be achieved. Moreover, in terms of building's Power Factor (PF), if the chiller operates at a 0.94 PF on AC and DC Power Factor can achieve a 1.0, there is potential for an additional 6% improvement in efficiency which starts to approach over a 10% gain in efficiency on the chiller.

The chiller 12 may be water cooled or air cooled.

A solar integrated chiller may provide direct DC power to the condenser fans of air-cooled chillers for example. Renewable energy sources 20 such as solar photovoltaic cells may be used to drive the air-cooled condenser fans. An on-board battery system may be used to buffer DC voltage swings that can occur from renewable energy sources 20.

The system integrates the DC distribution of chiller(s), renewable energies, battery storage and other DC driven components, in a building for example, while using the AC power from the grid to backfill when DC power cannot supply the entire load.

In the present system, energy may be fed back into the grid (G) and the chiller 12 may be supplied from multiple sources of power, consuming what energy can be harvested from renewable or other sources of energy sources 20 such as solar or wind power for example, and only using energy from the grid (G) to make up any deficiency in supply, as controlled by the power control module monitor 12.

As more and more buildings adopt the transition to DC powered buildings, a direct current chiller with a power control module according to the present disclosure drives building energy consumption down. For example, assume a 500-ton chiller running at an IPLV of 0.3313 kW/ton over 3500 hours per year with blended electricity rate of $0.11/kWh. This represents an annual energy cost of $63,775 per year. Therefore, a 10% savings from the direct current chiller with a power control module according to the present disclosure, the annual savings on this small single chiller is over $6,300 annually.

In addition to significant energy savings, the direct current chiller according to the present disclosure eliminates several components on the compressor thus reducing possible failure points whereby improving availability and reliability factor of the chiller.

In addition to the efficiency gains of DC power, the direct current chiller according to the present disclosure provides additional stability and reliability when dealing with power quality issues of an aging T&D infrastructure of an AC power system. An added benefit may be “ride through” capability versus sometimes difficult and controversial fast re-start options of AC chillers, which may be improvement for mission critical facilities such as Data Centers, Hospitals and manufacturing facilities where power interruptions, even at the micro scale, can cost these facilities millions of dollars in lost profits as a result of interrupted cooling inertia.

The Data Center industry continues to focus on driving down its power usage effectiveness (PUE), which means lowering energy consumption not used for customer's server energy. In addition to the energy savings DDC can provide, the ride through capability significantly improves chilled water response to power outages or power quality issues which is a critical service needed to protect servers. This ride through could also reduce the amount of emergency backup equipment required as restarting the chiller is no longer needed. In the event that a data center is not 100% DC driven, the direct current chiller with a power control module according to the present disclosure could be fed by the data center's UPS system thus eliminating an additional AC/DC conversion at the chiller.

With the addition of renewable or other DC power sources the present power controller module may use the commercially available power from the grid to complement whatever DC power is available with power from the grid, thereby ensuring maximum recovery of alternate power sources. Should the availability of the power exceed the consumption requirements of the chiller, excess power may be fed back into the power grid, or used to offset other loads external to the chiller. Alternately the excess power may be stored for later consumption through addition of battery storage (16). The stored power may later be used to complement insufficient renewable power, or even used to ensure grid demand was limited to avoid excess usage charges.

The present system is thus an integrated micro grid providing a ready consumption of renewable power to offset the high energy costs delivered through traditional poles and wire grid networks

With renewable energy continuing to gain market acceptance globally, renewable energy systems can be directly connected thus avoiding the energy losses and costly equipment associated with the AC/DC conversion of the renewable energy systems. This direct connect according to the present disclosure also eliminates additional grid protection equipment which can become quite costly and is another point of failure.

The scope of the claims should not be limited by the embodiments set forth in the examples, but should be given the broadest interpretation consistent with the description as a whole.

1- A system, comprising a power control module, at least one power supply and at least one DC load, said power control module interfacing said at least one DC load and the at least one power supply.

2- The system of claim 1, wherein said at least one power supply comprises at least one AC power supply and at least one DC power supply, said power control module, from said at least one AC power supply and said at least one DC power supply, supplying DC power to said at least one DC load.

3- The system of claim 2, wherein said power control module controls energy supply to the at least one DC loads from the at least one AC power supply and said at least one DC power supply

4- The system of claim 2, wherein in case of excess energy, said power control module at least one of: i) feeds back excess energy to the at least one AC power supply and ii) causes storage of extra energy.

5- The system of claim 1, wherein said at least one DC load is one of: high voltage DC loads and low voltage DC loads.

6- The system of claim 1, wherein said at least one DC load comprises a chiller comprising a DC powered compressor.

7- The system of claim 1, wherein said at least one DC load comprises comprising a chiller comprising a DC powered oil free magnetic bearing compressor.

8- The system of claim 1, wherein said at least one DC load comprises a chiller comprising a DC powered oil free magnetic bearing compressor, DC powered controls and powered valves.

9- The system of claim 1, wherein said at least one DC load comprises an air-cooled chiller with DC powered condenser coil fans.

10- The system of claim 1, wherein said at least one DC load comprises a water-cooled chiller.

11- A power supply integration method, comprising interfacing at least one DC load and at least power supply.

12- The method of claim 11, comprising interfacing at least one of: i) an AC power supply and ii) a DC power supply, and supplying, from the at least one of: i) an AC power supply and a ii) a DC power supply, DC power to the at least one DC load.

13- The method of claim 12, interfacing at least one AC power supply and at least one DC power supply and controlling energy supply to the at least one DC load from the at least one AC power supply and the at least one DC power supply.

14- The method of claim 12, comprising, in case of excess energy, at least one of: i) feeding back excess energy into the AC power supply and ii) causing storage of extra energy.

15- The method of claim 11, wherein the at least one DC load is one of: high voltage DC loads and low voltage DC loads.

16- The method of claim 11, wherein the at least one DC load comprises a chiller comprising a DC powered compressor.

17- The method of claim 11, wherein the at least one DC load comprises a chiller comprising a DC powered oil free magnetic bearing compressor.

18- The method of claim 11, wherein the at least one DC load comprises a chiller comprising a DC powered oil free magnetic bearing compressor, DC powered controls and powered valves.

19- The method of claim 11, wherein the at least one DC load comprises an air-cooled chiller with DC powered condenser coil fans.

20- The method of claim 11, wherein the at least one DC load comprises a water-cooled chiller.
